(19) United States
(12) Patent Application Publication
(10) Pub. No.: US 2015/0161078 A1
(43) Pub. Date: Jun. 11, 2015

(54) CONTENT MANAGEMENT

(71) Applicant: International Business Machines Corporation, Armonk, NY (US)

(72) Inventors: Uday K. Cholleti, Andhra Pradesh (IN); Srinivas Jandhyala, Hyderabad (IN); Balunaini Prasad, Bangalore (IN)

(73) Assignee: International Business Machines Corporation, Armonk, NY (US)

(21) Appl. No.: 14/101,418

(22) Filed: Dec. 10, 2013

(51) Int. Cl. G06F 17/21

(52) U.S. Cl. CPC G06F 17/211

(57) ABSTRACT

Embodiments include a system, computer-implemented method and computer program product for processing an image document. According to one embodiment, the method includes determining coordinates of an area defined by a region in the image document and generating a preference data based on the coordinates of the area and identification information of a user associated with the selected region. The method also includes associating the preference data with a setting and storing the preference data as a content element in a document object of the image document.

### BACKGROUND

The present invention relates to enterprise content management (ECM), and more specifically, to document processing in ECM. ECM relates to strategies, tools, processes used to capture, manage, store, preserve and deliver content and documents related to organizational processes. Thus, ECM is a means of organizing, storing managing an organization's unstructured and structured information, wherever that information exists. The content may include, but not limited to, images, email messages, instant messages, video and the like. Generally, paper documents are converted into electronic format through scanning. For example, paper documents may be scanned and the scanned documents may be stored as images in an ECM system. According to another example, the images may be generated by a computer system, wherein software may capture the image of the paper document. The images can also be device generated, such as satellite images, medical images, or images captured by a camera. Generally, ECM systems incorporate content security by providing mechanisms for ensuring that only authorized users access the content. Therefore, a particular content may be accessed by only an authorized user. These mechanisms are essential for maintaining the confidentiality of the content.

### SUMMARY

According to exemplary embodiments, there is provided a system, a system, a computer-implemented method and a computer program product for processing an image document. According to one embodiment, the method includes determining coordinates of an area defined by a region in the image document and generating a preference data based on the coordinates of the area and identification information of a user associated with the selected region. The method also includes associating the preference data with a setting and storing the preference data as a content element in a document object of the image document.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts an illustrative environment in accordance with aspects of the present invention.

FIG. 5 shows an exemplary flow for performing aspects of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

In exemplary embodiments, the characteristics may include and on-demand self-service, broad network access, resource pooling, rapid elasticity, and measured service. In an on-demand self-service, a cloud consumer can unilaterally provision computing capabilities, such as server time and network storage, as needed automatically without requiring human interaction with the service's provider. In broad network access, capabilities are available over a network and accessed through standard mechanisms that promote use by heterogeneous thin or thick client platforms (e.g., mobile phones, laptops, and PDAs). In resource pooling, the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). In rapid elasticity, capabilities can be rapidly and elastically provisioned, in some cases automatically, to quickly scale out and rapidly released to quickly scale in. To the consumer, the capabilities available for provisioning often appear to be unlimited and can be purchased in any quantity at any time. In a measured service, cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

In exemplary embodiments, the service models may include software as a service, platform as a service, and infrastructure as a service.

In Software as a service (SaaS), the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

In platform as a service (PaaS), the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

In infrastructure as a service (IaaS), the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

In exemplary embodiments, the deployment models may include a private cloud, a community clout, a public cloud and a hybrid cloud. In a private cloud, the cloud infrastructure is operated solely for an organization and it may be managed by the organization or a third party and may exist on-premises or off-premises. In a community cloud: the cloud infrastructure is shared by several organizations and supports a specific community that has shared concerns (e.g., mission, security requirements, policy, and compliance considerations) and it may be managed by the organizations or a third party and may exist on-premises or off-premises. In a public cloud, the cloud infrastructure is made available to the general public or a large industry group and is owned by an organization selling cloud services. In a hybrid cloud, the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

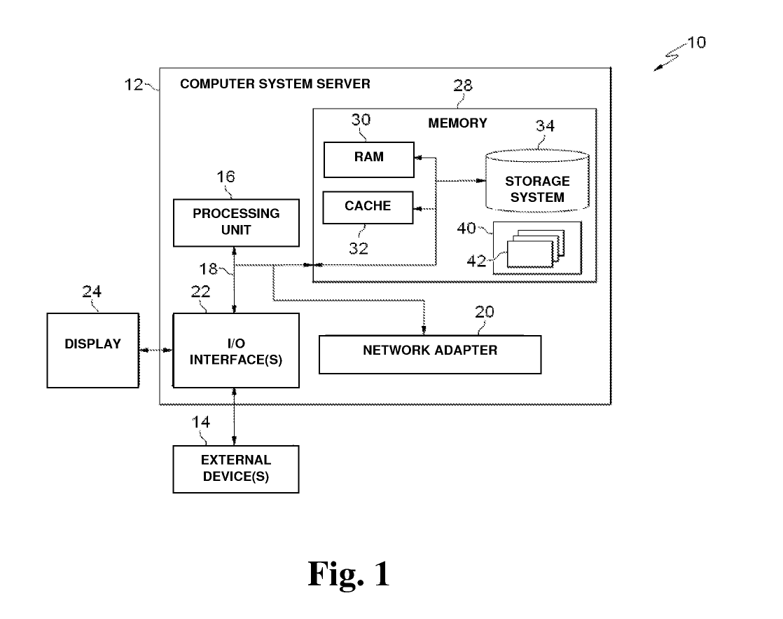

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

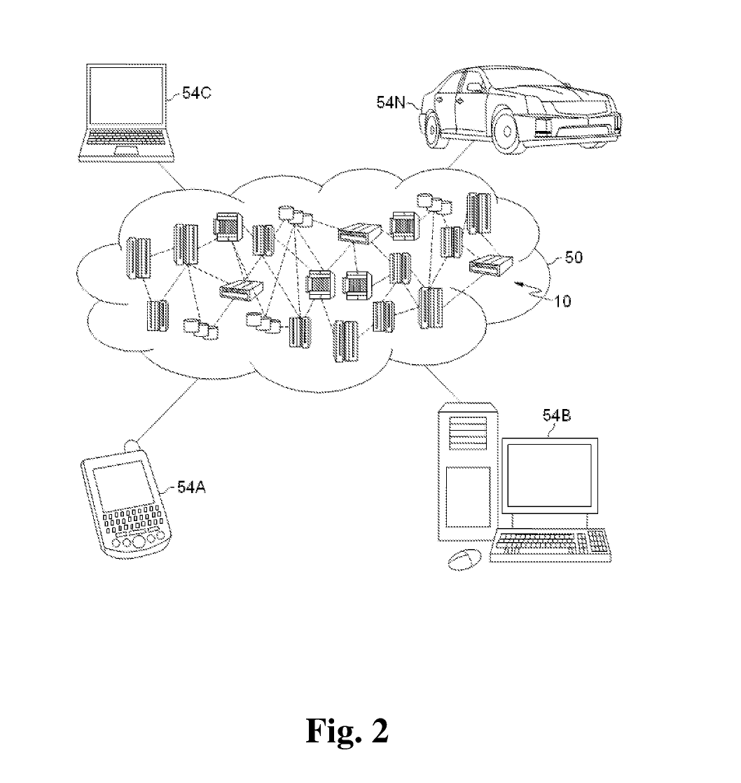

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

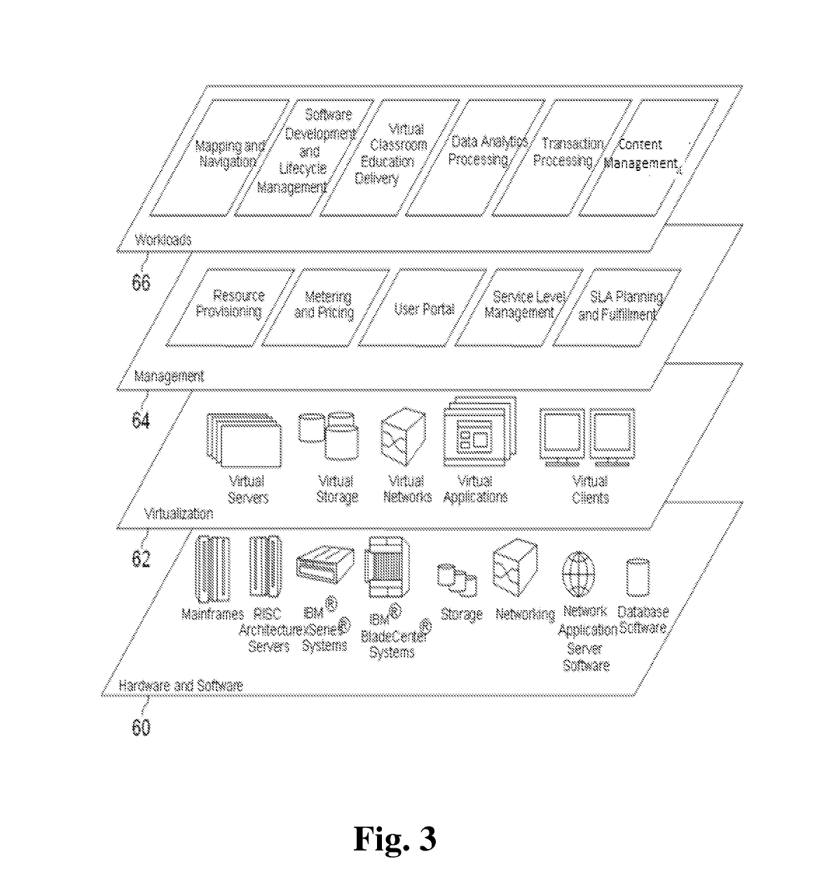

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network client, in one example IBM WebSphere® client; and database software, in one example IBM DB2®, database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA. Further shown in the management layer 64 is connection allocation, which represents the functionality that is provided under the embodiments of the present invention.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and consumer data storage and backup.

It is understood that all functions of the present invention as described herein typically may be performed by the document revision (workloads layer 66, which can be tangibly as modules of program code 42 of program/utility 40 of FIG. 1). However, this need not be the case. Rather, the functionality recited herein could be carried out/implemented and/or enabled by any of the layers 60-66 shown in FIG. 3.

It is reiterated that although this disclosure includes a detailed description on cloud computing, implementation of the teachings recited herein are not limited to a cloud computing environment. Rather, the embodiments of the present invention are intended to be implemented with any type of networked computing environment known now or later developed.

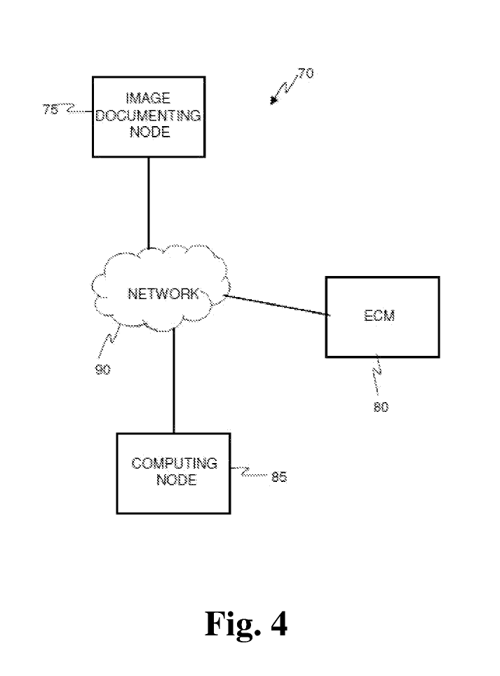

FIG. 4 depicts an illustrative environment 70 in accordance with aspects of the present invention. As shown in the example of FIG. 4, the environment 70 includes an image documenting node 75, an enterprise content management (ECM) system 80 and a computing node 85 operatively connected to a network 90. In general, the image documenting node 75 may include the computing device 54A, 54B, 54C, or 54N of FIG. 2 operated by a user for feeding image documents into the ECM system 80. The computing node 85 may include one or more of the computing devices 54A-N for accessing the image documents from the ECM system 80 or reviewing the image documents. The ECM system 80 may include the computer system 12 of FIG. 1. The network 90, may be a local area network (LAN), a general wide area network (WAN), and/or a public network (e.g., the Internet) via network adapter (e.g., the network adapter 20 in FIG. 1).

According to one embodiment of the present invention, the image documenting node 75 is adapted to feed image documents into the ECM system 80. The ECM system 80 is adapted to store the image documents into the storage system (e.g., the storage system 34 in FIG. 1). An administrator or a user can retrieve an image document from the ECM system 80 via the computing node 85. In general, an image document stored into an ECM system comprises a document object comprising properties and content elements. In general, the properties may include information relating to name, description, security and the like. The content elements list out actual content in the image document. A document object may have one or more content elements. For example, a single content element may correspond to a portion of the image document. In this case, document object may comprise a plurality of content elements corresponding to different portions of the image document. According to one embodiment of the present invention, user preference information may be stored as a content element in the document object. The user preference information may relate to entitlement or enhancement information of the image document. For example, one or more regions for which entitlement or enhancement information may be required to be stored may be selected by an administrator or a user.

For example, the administrator may retrieve the image document from the ECM system 80 using the computing node 85. According to one embodiment of the present invention, the administrator may retrieve the image document through the document object of the image document. The image document may be accessed using the content elements in the document object. The document object may comprise one or more content elements corresponding to the content of the image document. In case the document object comprises more than one content element corresponding to the content of the image document, the respective portion of the content of the image may be accessed by the administrator. According to another embodiment, the administrator may retrieve the image document directly from the ECM system 80. On retrieval of the image document or a portion of the image document, the administrator may select a region in the image document or the portion of the image document for which user preference information is to be stored.

The computing node 85 may be configured to determine the coordinates of an area defined by the region selected. A preference data comprising the coordinates of the area determined and identification information of one or more users associated with the region is generated. For example, the identification information of a user may be a security identifier (SID) of a user identified by a light weight access protocol (LDAP) directory server. The identification information of one or more users may be associated with a setting. For example, the setting may correspond to entitlement or enhancement information associated with a user corresponding to the region of the document image. The setting may be provided as input by an administrator or by a user. For example, in embodiments wherein the selected region is to be masked the setting may be provided by an administrator. In embodiments, wherein selected region is enhanced, the setting may be provided by the user. Thus, the setting may be based on the user's privileges and preferences. For example, the entitlement information may be based on the privileges associated with a user. The enhancement information may be based on the preferences of the user. According to one embodiment of the present invention, the preference data may be stored as a content element in the document object of the image document. The setting associated with the identification information of the user can also be stored as the content element in the document object of the image document. This provides the advantage of processing the image based on the setting associated with the image when accessed by a user. According to one embodiment of the present invention, the setting may be stored as a child in the preference data associated with the identification information of the user.

For example, in implementations, where the setting corresponds to entitlement, the selected region may be hidden from non-privileged users. The selected region may correspond to confidential information which is required to be accessible to only privileged users. In implementations, where the setting corresponds to enhancement, the selected region may be enhanced as per the preferences of the user. According to one embodiment of the present invention, for enhancing or hiding the selected region, the setting may be such that values of at least a sub-set of pixels within the area defined by the coordinates of the selected region may be modulated. For example, the setting may be a filter and the values of the pixels may be modulated responsive to the filter. The filter may be implemented as a lookup table.

According to one embodiment of the present invention, for hiding or masking the selected region, the lookup table may comprise a value to which the values of at least the sub-set of pixels within the area may be modulated. This will modulate the sub-set of pixels to the same value. For example, the sub-set of pixels can be modulated to the same value in case graying of the selected region is desired. According to another embodiment, if a desired text or image is to be displayed over the selected region, the lookup table may be a two dimensional matrix comprising pixel values to which the sub-set of pixels are to be modulated. To achieve this, the two dimensional matrix may identify a pixel and the value to which a pixel of the sub-set of pixels is to be modulated. For example, pixels values in the lookup table may correspond to characters, for example a logo or trademark of a company, or an image. Thus, modulating the values of at least a sub-set of pixels within the selected region to display characters or an image hides or masks a region of an image document if the user is not privileged to access the content.

For enhancement of the selected region, the lookup table may be a two dimensional matrix. The two dimensional matrix may list out the value to which a respective pixel is to be modulated for enhancement of the selected region. For example, the two dimensional matrix may list out the values to which the respective sub-set of pixels are to be modulated. According to another example, the two dimensional matrix may list out the values by which current value of the respective sub-set of pixels is to be increased or decreased to achieve the enhancement. As described above, the look up table can be stored as a content element.

According to one embodiment of the present invention, the preference data may comprise identification information of one or more users or a group. In case of a group the members of the groups may have the entitlement or enhancement rights as defined by the setting associated with the identification information. For adding a user or removing a user, the preference data may be updated. For example, in case entitlement, this update may be done by the administrator. In case of enhancement, the individual user may update the preference data for addition or removal.

According to another embodiment of the present invention, the setting may comprise an image which is to be displayed instead of the selected region for a non-privileged user. The image may be aligned to the coordinates of the area defined by the selected region. Thus, when the document image is accessed by a non-privileged user, the image is displayed instead of the selected region. For example, the image may correspond, but not limited to, a logo of a company, a trademark of a company, and a watermark.

According to one embodiment of the present invention, a title of the preference data stored as a content element in the document object may correspond to a unique identity of the content element corresponding to the content of the image. For example, the title of the preference data may comprise the unique identity of the content element corresponding to the content of the image to which the preference data relates. This provides the advantage of identifying the content element corresponding to the content of the image to which the preference data relates. In embodiments, where the document object comprises a plurality of content elements corresponding to the content of the image document, this assists in identifying the corresponding content element easily.

One advantage of storing the preference data as a content element is that the security applicable to the image document is also applicable to the preference data. Thus, additional security for the preference data is not required to be maintained. Additionally, the preference data stored as a content element provides the advantage of being scalable, as users can be added or removed and the filter modified as per the requirement.

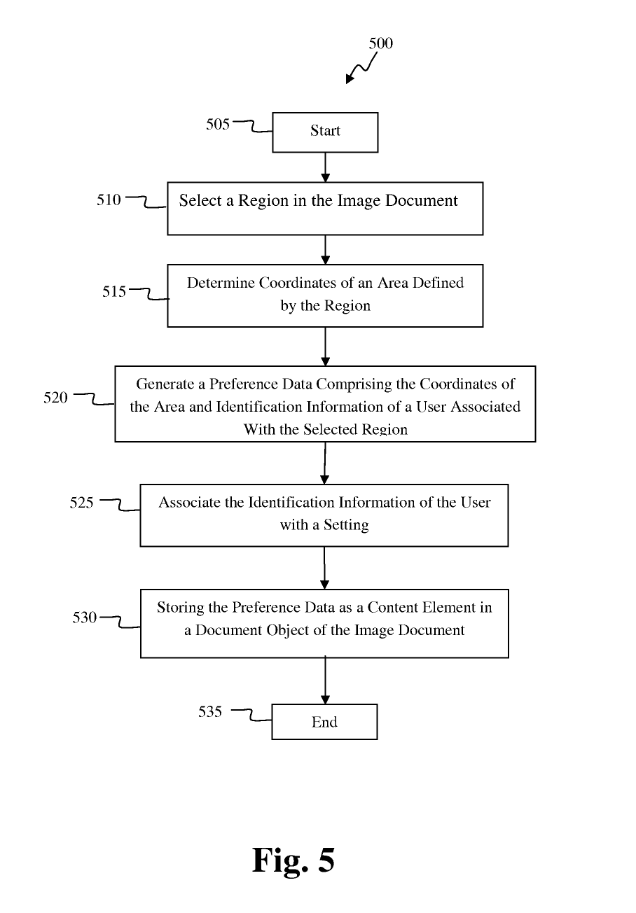

FIG. 5 depicts an exemplary flow for a process 500 in accordance with aspects of the present invention. In embodiments, the process 500 can be performed by the communication adapter 95 in FIG. 4.

At block 505, the process starts. At block 510, a region of an image document is selected. The image document may be retrieved via a computing node (e.g., the computing node 85 in FIG. 4) from an ECM system (e.g., the ECM system 80 in FIG. 4). At block 515, the computing node determines the coordinates of an area defined by the selected region. For example the coordinates may be determined using the coordinates of the pixels. At block 520, the computing node generates a preference data comprising the coordinates of the area and an identification information of a user associated with the selected region. At block 525, the computing node associates the identification of the user with a setting. At block 530, the preference data is stored as a content element in a document object of the image document in the ECM system. At block 535, the process ends.

The embodiments described herein provide selective content entitlement and/or enhancement in an ECM environment. The term “selective” herein refers to a selection of a portion of an image document made by a user or an administrator. For example, a selected region of an image document can be masked or hidden. For example, the selected region may correspond to confidential information and may be hidden for individuals not privileged to view the information. This provides the advantage hiding only the selected portion in the image document and displaying the rest of the image document to an unprivileged individual. Thus, access to the complete document is not blocked but only to the portion corresponding to confidential or sensitive information. For example, in a map, sensitive data be hidden and only the general data may be visible to individuals. Additionally, the embodiments may be implemented for enhancing the selected region. For example, in healthcare applications, different doctors may be interested in different vies of a patient's diagnostic images like computer tomography (CT) scans, X-ray images, and the like. The doctor may access the ECM system 80 and select the desired region in the image document, apply the filter to the selected region for enhancement and save the image document. The selected region and the enhance filter is saved as preference data as a content element. The doctor may view the enhanced selected region whenever required by accessing the image document from the ECM system 80. This eliminates the doctor from applying the filter each time he in interested in viewing the enhanced image or store a copy of the enhanced image. Different doctors may apply different filters to the respective selected region for enhancement. Therefore, the filter being stored as a preference data in as a content element eliminates the requirement of applying the filter each time for viewing the enhanced image and also reduces the consumption of memory as the enhanced image is not required to be stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1.-7. (canceled)

8. A system implemented in hardware, comprising a computer infrastructure operable to:
determine coordinates of an area defined by a region in the image document;
generate a preference data based on the coordinates of the area and an identification information of a user associated with the selected region; and
associate the preference data with a setting.

9. The system of claim 8, wherein the computer infrastructure is operable to store the setting and the preference data as a content element in a document object of the image document.

10. The system of claim 8, wherein the computer infrastructure is further operable to modulate values of at least a sub-set of pixels within the area based on the setting associated with the preference data.

11. The system of claim 10, wherein the computer infrastructure is operable to modulate values of at least the sub-set of pixels for masking the region in the image document.

12. The system of claim 10, wherein the computer infrastructure is operable to modulate values of at least the sub-set of pixels to represent an additional image such that the region in the image document is masked.

13. The system of claim 10, wherein the computer infrastructure is operable to modulate values of at least said sub-set of pixels for enhancing the region in the image document.

14. The system of claim 8, wherein the setting includes a filter and wherein the computer infrastructure is further operable to modulate the values of at least said sub-set of pixels responsive to the filter.

15.-20. (canceled)
